(19) United States
(12) Patent Application Publication
(10) Pub. No.: US 2018/0088973 A1
(43) Pub. Date: Mar. 29, 2018

(54) METHODS AND SYSTEMS FOR INTERCONVERSIONS AMONG VIRTUAL MACHINES, CONTAINERS AND CONTAINER SPECIFICATIONS

(71) Applicant: DINESH SUBHRAVETI, san jose, CA (US)

(72) Inventor: DINESH SUBHRAVETI, san jose, CA (US)

(21) Appl. No.: 15/275,435

(22) Filed: Sep. 25, 2016

(51) Int. Cl. G06F 9/455; G06F 9/445

(52) U.S. Cl. CPC G06F 9/45558; G06F 2009/45562; G06F 8/60

(57) ABSTRACT

In one example aspect, a method obtains a file system of a virtual machine. The virtual machine comprises a plurality of applications. The plurality of applications are started through an initialization system when the virtual machine is initialized. The method captures a set of contents of the file system of the virtual machine. The method captures a metadata of the file system of the virtual machine. The method captures a state of file system of virtual machine. The method converts the plurality of applications deployed in the virtual machine into a set of containers by creating a separate container image for each application of the plurality of applications deployed in the virtual machine. Each container comprises an application packaging medium and is built based on a container specification. The container specification is derived from the set of contents of the file system of the virtual machine, metadata of the file system of the virtual machine, and the state of file system of virtual machine. The method includes using the container specification to generate a second virtual machine.

### BACKGROUND

### 1. Field

This application relates generally to computer virtualization, and more particularly to a system, method and article of manufacture for interconversions among virtual machines, containers and container specifications.

2. Related Art

It is noted that a virtual machine can have specified drivers that correspond to the specific proprietary cloud-computing platform it is implemented in. In this way, a virtual machine may not be portable. Additionally, some proprietary cloud-computing platforms may not enable container-based applications. Moreover, some proprietary cloud-computing platforms may impose limitations on container-based applications such that a user may wish to implement the application using a virtual machine. Manual conversion of virtual machines to containers can be time consuming and introduce coding errors. Accordingly, improvements to converting virtual machines to a containers and vice versa can be beneficial.

### BRIEF SUMMARY OF THE INVENTION

In one example aspect, a method obtains a file system of a virtual machine. The virtual machine comprises a plurality of applications. The plurality of applications are started through an initialization system when the virtual machine is initialized. The method captures a set of contents of the file system of the virtual machine. The method captures a metadata of the file system of the virtual machine. The method captures a state of file system of virtual machine. The method converts the plurality of applications deployed in the virtual machine into a set of containers by creating a separate container image for each application of the plurality of applications deployed in the virtual machine. Each container comprises an application packaging medium and is built based on a container specification. The container specification is derived from the set of contents of the file system of the virtual machine, metadata of the file system of the virtual machine, and the state of file system of virtual machine. The method includes using the container specification to generate a second virtual machine.

### BRIEF DESCRIPTION OF THE DRAWINGS

The present application can be best understood by reference to the following description taken in conjunction with the accompanying figures, in which like parts may be referred to by like numerals.

FIG. 1 illustrates an example system for interconversion of containers, Docker-Files and/or virtual machines, according to some embodiments.

FIG. 2 depicts an exemplary computing system that can be configured to perform any one of the processes provided herein.

FIG. 3 illustrates an example process for interconversions among virtual machines, containers and container specifications, according to some embodiments.

FIG. 4 illustrates, in block diagram format, an example process for converting a virtual machine(s) to a container(s), a container(s) to a Docker-File(s) and a Docker-File(s) to a virtual machine(s), according to some embodiments.

FIG. 5 illustrates a process for converting a virtual machine into one or more containers, according to some embodiments.

FIG. 6 illustrates an example process decomposing a composite container into individual application containers, according to some embodiments.

FIG. 7 illustrates an example process for converting a container's binary file into a text file representing the container specification, according to some embodiments.

FIG. 8 illustrates an example process for converting a container's binary file into a text file representing the container specification, according to some embodiments.

FIG. 9 illustrates an example process of converting a Docker-File to a virtual machine in a targeted cloud-computing platform, according to some embodiments.

### DESCRIPTION

The Figures described above are a representative set, and are not an exhaustive with respect to embodying the invention.

### DESCRIPTION

Disclosed are a system, method, and article of manufacture for interconversions among virtual machines, containers and container specifications. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “tone example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line, types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

The following definitions provided by way of example and not of limitation.

Application programming interface (API) specifies how some components should interact with each other.

Cloud-computing can be a kind of Internet-based computing that provides shared processing resources and data to computers and other devices on demand. It can be a model for enabling ubiquitous, on-demand access to a shared pool of configurable computing resources (e.g., networks, servers, storage, applications and services), which can be rapidly provisioned and released with minimal management effort. Cloud computing and storage solutions can provide users and enterprises with various capabilities to store and process their data in third-party data centers.

Container can be a server virtualization instance used in operating system-level virtualization. Containerization can be a server virtualization method in which the kernel of an operating system allows the existence of multiple isolated user-space instances, instead of just one.

Distribution can be an operating system-package composed of, inter alia: the kernel, GNU tools and libraries, additional software based on a package management system, etc.

Docker is an open-source project that automates the deployment of applications inside software containers, by providing an additional layer of abstraction and automation of operating-system-level virtualization on Linux. Docker uses the resource isolation features of the Linux kernel such as cgroups (e.g. a Linux kernel feature that limits, accounts for, and isolates the resource usage (e.g, CPU, memory, disk I/O, network, etc.) of a collection of processes) and kernel namespaces, and a union-capable file system such as aufs and others to allow independent “containers” to run within a single Linux instance, avoiding the overhead of starting and maintaining virtual machines.

Hypervisor can be a piece of computer software, firmware and/or hardware that creates and runs virtual machines.

Image can be the state of a computer system stored in some form.

Plug-in can be a piece of software that enhances another software application and usually can be run independently

Virtual machine (VM) can be an emulation of a given computer system. Virtual machines can operate based on a computer architecture and functions of a real or hypothetical computer, and their implementations may involve specialized hardware, software, or a combination.

Exemplary Environment and Architecture

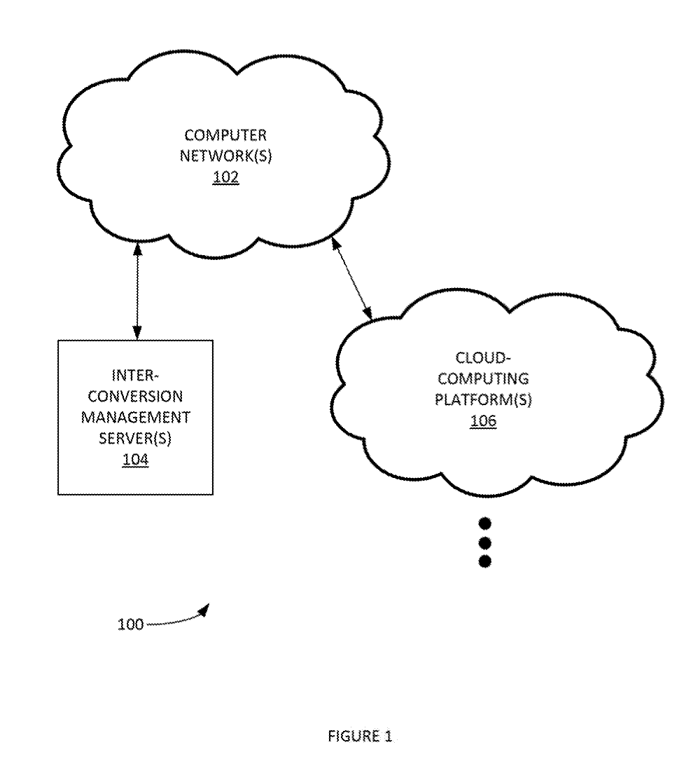

FIG. 1 illustrates an example system 100 for interconversion of containers, Docker-Files and/or virtual machines, according to some embodiments. The entities of system 100 can communicate via computer network(s) 102.

Inter-conversion management server(s) 104 can implement the various processes provided herein. For example, inter-conversion management server(s) 104 can implement processes 400-900 provided infra. Inter-conversion management server(s) 104 can be implemented in a cloud-computing platform as well.

Cloud-computing platform(s) 106 can provided cloud-computing services. Various virtual machines, containers and/or Docker-Files (or similar systems/functionalities) can be present in cloud-computing platform(s) 106.

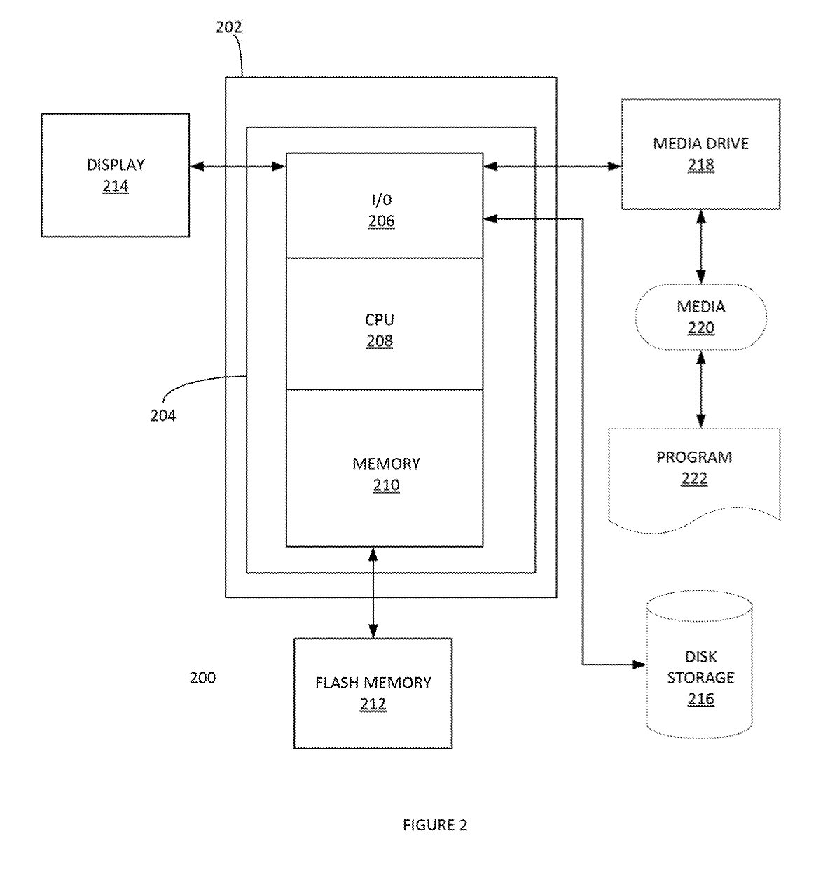

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry OF other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. In another example, computing system 200 can be configured as a mobile device and include such systems as may be typically included in a mobile device such as GPS systems, gyroscope, accelerometers, cameras, etc.

Process Overview

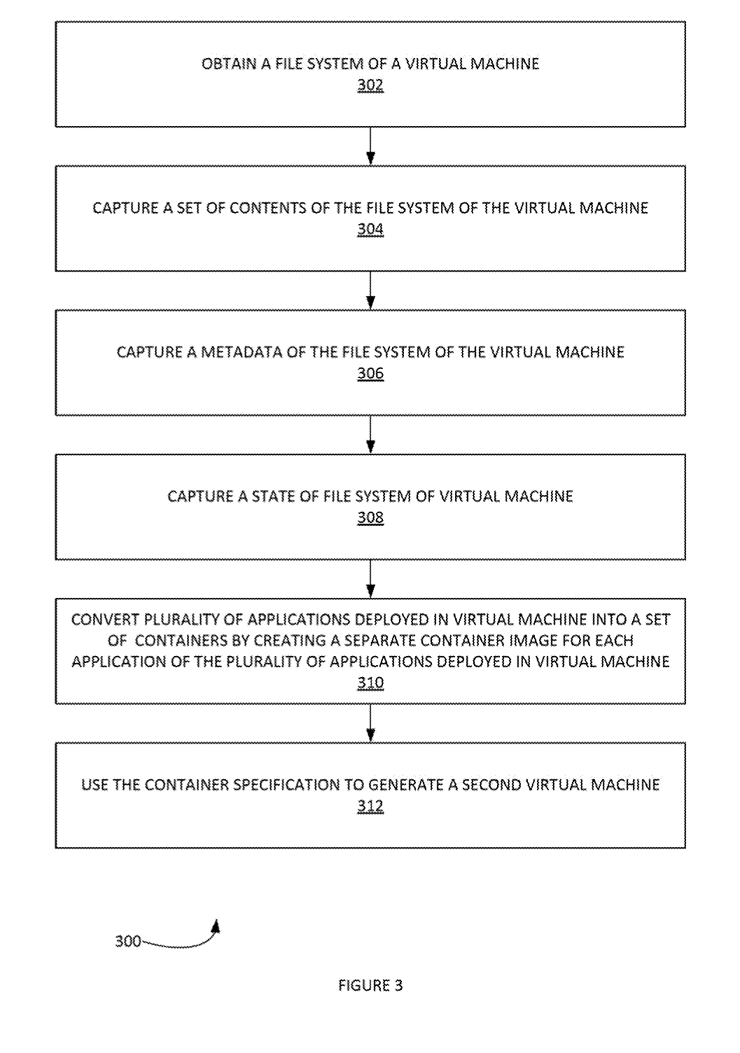

FIG. 3 illustrates an example process 300 for interconversions among virtual machines, containers and container specifications, according to some embodiments. In step 302, process 300 obtains a file system of a virtual machine. The virtual machine includes a plurality of applications. The plurality of applications are started through an initialization system when the virtual machine is initialized. In step 304, process 300 captures a set of contents of the file system of the virtual machine. In step 306, process 300 captures a metadata of the file system of the virtual machine. In step 308, process 300 captures a state of file system of virtual machine. In step 310, process 300 converts the plurality of applications deployed in the virtual machine into a set of containers by creating a separate container image for each application of the plurality of applications deployed in the virtual machine. Each container comprises an application packaging medium and is built based on a container specification. The container specification is derived from the set of contents of the file system of the virtual machine, metadata of the file system of the virtual machine, and the state of file system of virtual machine. In step 312, process 300 uses the container specification to generate a second virtual machine.

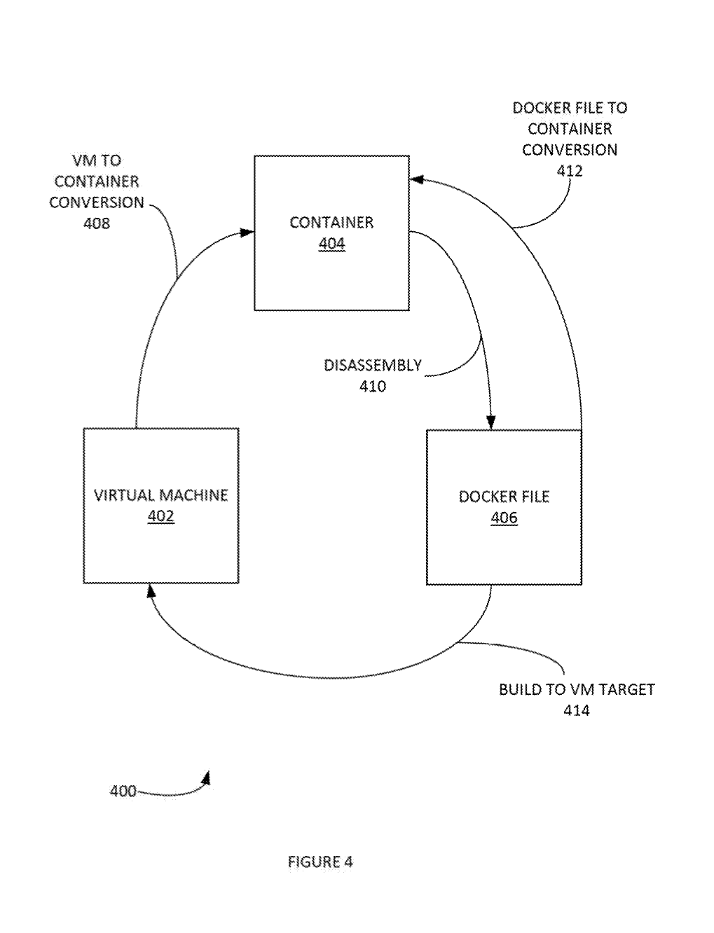

FIG. 4 illustrates, in block diagram format, an example process 400 for converting a virtual machine(s) 402 to a container(s) 404, a container(s) 404 to a Docker-File(s) 406 and a Docker-File(s) 406 to a virtual machine(s) 402, according to some embodiments.

A virtual machine (VM) 402 can include one or more applications, application configurations, application dependencies, application metadata, etc. Dependencies can enable an application to function independently. Virtual machine 402 can be converted to one or more containers 404 in process 408. Process 408 can obtain the file system of virtual machine 402. Process 408 can capture the contents of said file system as well as any additional metadata. Virtual machine 402 can include a plurality of applications. Process 408 can be used to convert each application to a container.

In one example, process 408 can capture state of file system of virtual machine 402. Virtual machine 402 can have multiple applications. The applications are started through the init system when the virtual machine 402 comes up. Process 408 can review the metadata on the init system and identify applications deployed in the virtual machine 402. Process 408 can then create a separate container image for each application contained in virtual machine 402. In Unix-based computer operating systems, init (short for initialization) is the first process started during booting of the computer system. Init is a daemon process that continues running until the system is shut down. It is the direct or indirect ancestor of all other processes and automatically adopts all orphaned processes. Init is started by the kernel using a hard-coded filename; a kernel panic will occur if the kernel is unable to start it. Init is typically assigned process identifier one Init system is responsible for bringing up the default services hosted by the server machine. Examples of init systems include the system v init system or systemd which is a more recent implementation.

Each container produced by the conversion process would initially contain the entire file system state of the original virtual machine, including pieces of data that may not be pertinent to the specific application represented by that container. Process 408 may include an optimization step where data that is not relevant for the application is removed from the container representing that application. Particularly, the portions of the container data relevant for the application can be identified by through a trial run of the application and monitoring the data accessed by it. Any portions of the file system referenced by the application during the trial run is clearly required and included in the final target container built for that application. While this is an optimization step, the entire state of the original virtual machine can be conservatively included in the container.

Container(s) 404 can include an application, application dependencies, application metadata, etc. A container can be an application packaging medium. A container can be built based on a specification. It is noted that process 500 provided infra can be used to convert virtual machine 402 to container 404 as well. The specification can indicate the contents of a container image. The specification can be encoded in form of a sequence of instructions which when applied the product will be container. Docker-File 406 is an example of the container specification.

In process 412, Docker-Files 406 can be used to build container(s) 404 and/or virtual machine(s) 402. As used herein, a Docker-File can refer to a container image specification used by Docker, an open-source project that automates the deployment of applications inside software containers, by providing an additional layer of abstraction and automation of operating-system-level virtualization on Linux. Docker uses the resource isolation features of the Linux kernel such as cgroups (e.g. a Linux-kernel feature that limits, accounts for, and isolates the resource usage (e.g. CPU, memory, disk I/O, network, etc.) of a collection of processes) and kernel namespaces, and a union-capable file system such as aufs (advanced multi-layered unification filesystem) and others to allow independent ‘containers’ to run within a single Linux instance, avoiding the overhead of starting and maintaining virtual machines.

Process 410 can be a disassembly process. Process 410 is used to generate a container specification (e.g. of a Docker-File) from a container. Process 410 can convert the container binary images into corresponding container specification. The specification can be a sequence of instructions. This sequence of instructions can then be used as a source for a build process (e.g. process 414 that builds virtual machine 402 for the target cloud-computing platform and/or other computing environment).

The process of producing a virtual machine for a target cloud platform involves choosing the appropriate base operating system image built for the target cloud and layering the application state as indicated by the container specification on top of it. The application state itself could be directly embedded into the target VM or it could be partially or fully separated from the base VM image through use of container based isolation mechanisms. In the case where the application state is fully separated from the base VM image, the application is simply run as a container on top of the VM. In the case where the application state is partially separated from the base VM image, specific portions of the application state that would otherwise conflict with the state of the base VM could be isolated through mechanisms that provide separate namespaces for those state elements.

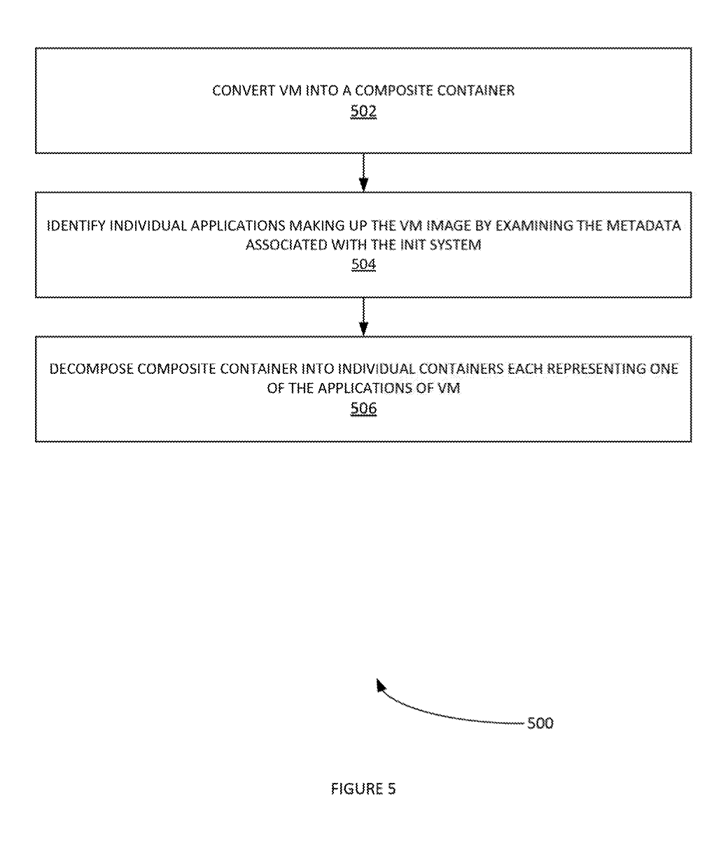

FIG. 5 illustrates a process 500 for converting a virtual machine into one or more containers, according to some embodiments. In step 502, process 500 can convert a virtual machine into a composite container. In step 504, process 500 can identify individual applications making up the virtual-machine image by examining the metadata associated with the init system. Process 500 can convert the virtual machine into a container form factor but it can continue to run an init process which brings up the other applications. Alternatively, the entry point of the container can be set to the specific application that the container represents. Step 506 decomposes the composite container into individual application containers can also involve the optimization of removing irrelevant state from those containers as described supra.

Process 500 can capture state of file system of the virtual machine. For example, a virtual machine may have multiple applications. When an application is started, the virtual machine can be initiated through an init process. Process 500 can review the metadata associated with the file system and determine which applications to initiate (e.g. by default). Process 500 can identify applications deployed in the virtual machine. Process 500 then creates a separate container image for each application contained in the virtual machine. These separate containers can be run separately. For example, each container can be implemented across different machines and/or cloud-computing platforms.

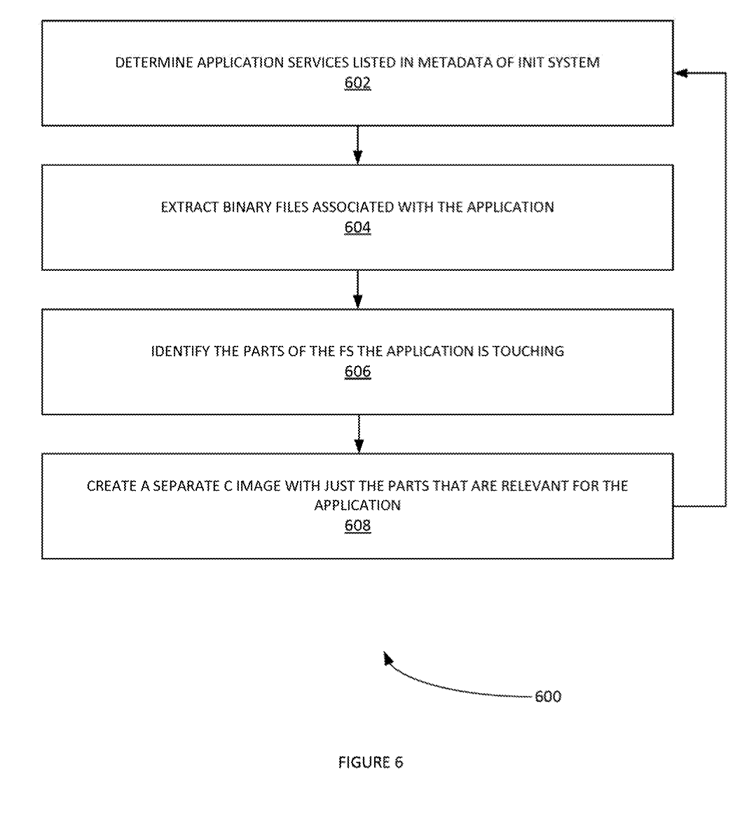

FIG. 6 illustrates an example process 600 decomposing a composite container into individual application containers, according to some embodiments. Process 600 can be implemented through fingerprinting. Fingerprinting can be a process of uniquely identifying data by extracting from it a known key. In step 602, process 600 can determine application services listed in metadata of init system. In step 604, process 600 can extract binary files associated with the application. In step 606, process 600 can identify the parts of the file system the application is touching. In step 608, process 600 can create a separate c image with just the parts that are relevant for the application. Process 600 can create a separate container image with the parts of the virtual machine that are relevant for the application (e.g., metadata, dependencies, etc.). Process 600 can be repeated for each application to be extracted out of the composite container derived from a virtual machine. Process 600 can be used to implement process 500.

It is noted that processes 500 and 600 can generate binary files. A Docker-File can be utilized to provide visibility into binary files (e.g. a computer file that is not a text file and/or is in a binary format). A Docker-File can be a text representation of contents of a container image.

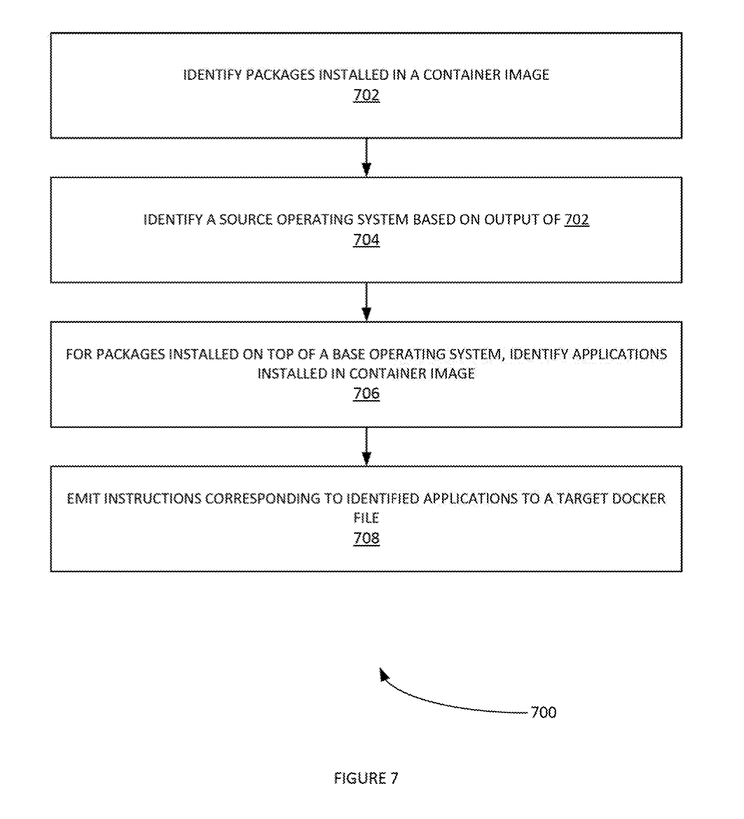

FIG. 7 illustrates an example process 700 for converting a container's binary file into a text file representing the container specification, according to some embodiments. For example, process 700 can convert binary container images into a container specification which is a sequence of instructions. The text file can then be used as a source for a build process. For example, the container specification can be used by a Docker functionality to build a virtual machine in a targeted cloud-computing platform. For example, process 700 can convert container into container specification.

In some embodiments, in step 702, process 700 can identify packages installed in a container image. In step 704, process 700 can identify a source operating system based on output of 702. In step 706, for packages installed on top of a base operating system, process 700 can identify applications installed in container image. In step 708, process 700 can emit instructions corresponding to identified-applications to a target Docker-File.

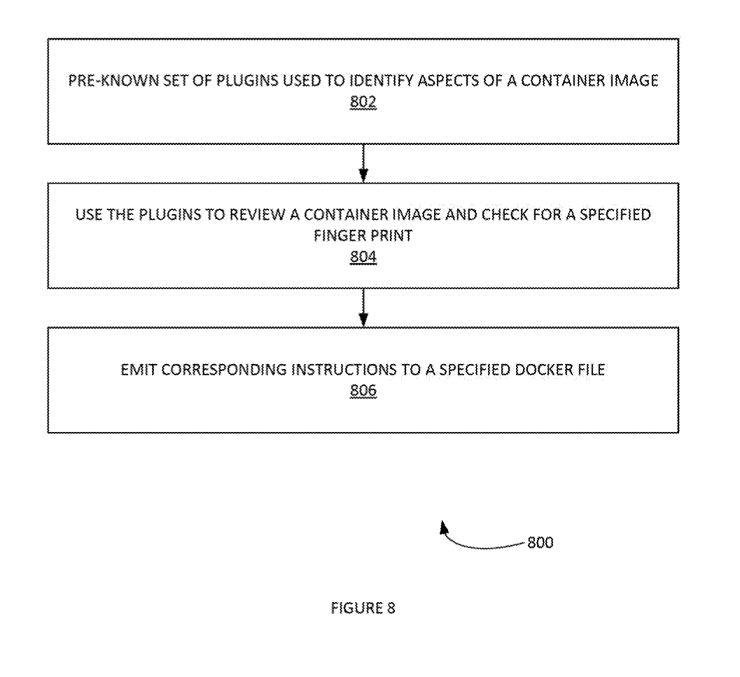

FIG. 8 illustrates an example process 800 for converting a container's binary file into a text file representing the container specification, according to some embodiments. Process 800 can use set of plugins (e.g. identified during a composite disassembly process, etc. to identify various contents of a container. For example, a particular plugin can identify a distribution of the container image. Another plug in can be used to identify one or more packages installed in the container image. Another plug in can identify a specific configuration has been applied to the container image. Process 800 can iterate over each available plugin.

Accordingly, in step 802, process 800 can provide a pre-known set of plugins used to identify aspects of a container image. A plugin can be used to identify one or more fingerprints used to identify aspects of a container image. In step 804, process 800 can use the plugins to review a container image and check for a specified finger print and/or set of finger prints associated with a plugin. Process 800 can invoke each plug in in turn to examine the container image so it can produce said instructions based on located finger prints. In step 806, when a plug in determines a match with a finger print, process 800 can emit corresponding instructions to a specified Docker-File. The instructions can include a portion of a container specification used to build the aspect of the container image (e.g. an application, application metadata, application dependencies, etc.). A finger print can be associated with a set of instructions to build an associated aspect of a container image. If any binary data remains that is not identified by any plug in, it can be captured as build context that goes with the Docker-File and a corresponding ADD instructions are emitted into the Docker-File. This ‘blobbed’ data can be provided to a target virtual machine and/or container built by the Docker-File. It is noted that a Docker-File can be (re)converted to a container and/or a virtual machine.

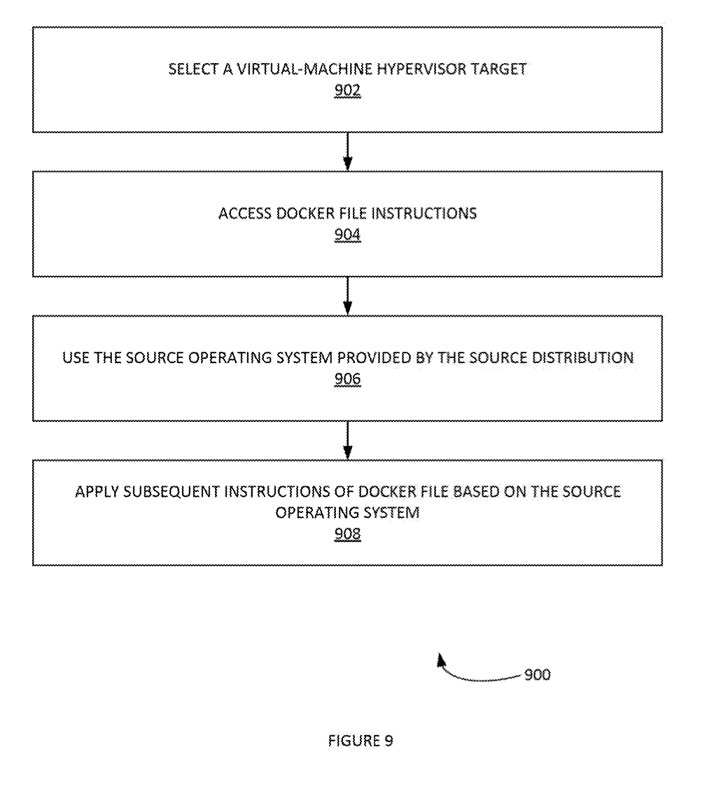

FIG. 9 illustrates an example process 900 of converting a Docker-File to a virtual machine in a targeted cloud-computing platform, according to some embodiments. As noted supra, a virtual machine can have specified drivers that correspond to a proprietary cloud-computing platform it is implemented in. In this way, a virtual machine may not be portable. Process 900 can build a virtual machine from a Docker-File. The virtual machine can run the same application(s) as a container built from the Docker-File. In step 902, process 900 can select a virtual-machine hypervisor target. In this way, process 900 can build the virtual machine image for a specified cloud-computing platform. In this way, an application can be portable across multiple cloud-computing platforms.

In step 904, process 900 can access Docker-File instructions. For example, a ‘FROM’ instruction can provide the base distribution. In step 906, process 900 can use the base operating system provided by the source distribution. In step 908, process 900 can apply subsequent instructions of Docker-File to the base operating system.

Accordingly, process 900 can determine that it is building the virtual machine for a Microsoft Azure® cloud-computing platform. Process 900 can then apply each instruction on top of a base virtual-machine image with instructions to run various applicable commands. The virtual machine can then be deployed to the target Microsoft Azure® cloud-computing platform by determining a correct target virtual-machine image for the Microsoft Azure®cloud-computing platform and building it. In this way, a user interface doesn't change whether the application is deployed in a container or a virtual machine.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method comprising:
obtaining a file system of a virtual machine, wherein the virtual machine comprises a plurality of applications, wherein the plurality of applications are started through an initialization system when the virtual machine is initialized;
capturing a set of contents of the file system of the virtual machine;
capturing a metadata of the file system of the virtual machine;
capturing a state of file system of virtual machine;
converting the plurality of applications deployed in the virtual machine into a set of containers by creating a separate container image for each application of the plurality of applications deployed in the virtual machine, wherein each container comprises an application packaging medium and is built based on a container specification, and wherein the container specification is derived from the set of contents of the file system of the virtual machine, metadata of the file system of the virtual machine, and the state of file system of virtual machine; and
using the container specification to generate a second virtual machine.

2. The computerized method of claim 1, wherein the container specification comprises a Docker-File.

3. The computerized method of claim 2, wherein the Docker-File comprises a set of instructions that automates the deployment of applications inside a software container by providing an additional layer of abstraction and automation of operating-system-level virtualization on a Linux® operating system.

4. The computerized method of claim 1, wherein the virtual machine comprises an application configuration file, an application dependency and an application metadata file.

5. The computerized method of claim 4 further comprising:
reviewing the metadata on the initialization system to identify the plurality of applications deployed in the virtual machine.

6. The computerized method of claim 1, wherein the initialization process comprises a first Process started during a booting process of the computer system and continues as daemon process that continues running until the computer system is shut down.

7. The computerized method of claim wherein the container specification indicates the contents of a container image, and wherein the container specification is encoded in form of a sequence of instructions that generates each container.

8. The computerized method of claim 1 further comprising:
targeting the second virtual machine for implementation on a specified cloud platform by selecting an appropriate base-operating system image built for the specified cloud platform.

9. The computerized method of claim 8 further comprising:
layering an application state of each application in the second virtual machine as indicated by the container specification.

10. A computing system for implementing comprising:
a processor configured to execute instructions;
a memory containing instructions when executed on the processor causes the processor to perform operations that:
obtain a file system of a virtual machine, wherein the virtual machine comprises a plurality of applications, wherein the plurality of applications are started through an initialization system when the virtual machine is initialized;
capture a set of contents of the file system of the virtual machine;
capture a metadata of the file system of the virtual machine;
capture a state of file system of virtual machine;
convert the plurality of applications deployed in the virtual machine into a set of containers by creating a separate container image for each application of the plurality of applications deployed in the virtual machine, wherein each container comprises an application packaging medium and is built based on a container specification and wherein the container specification is derived from the set of contents of the file system of the virtual machine, metadata of the file system of the virtual machine, and the state of file system of virtual machine; and
use the container specification to generate a second virtual machine.

11. The computing system of claim 10, wherein the container specification comprises a Docker-File.

12. The computing system of claim 11, wherein the Docker-File comprises a set of instructions that automates the deployment of applications inside a software container by providing an additional layer of abstraction and automation of operating-system-level virtualization on a Linux® operating system.

13. The computing system of claim 10, wherein the virtual machine comprises an application configuration file, an application dependency and an application metadata file.

14. The computing system of claim 13, wherein the memory further contains instructions when executed on the processor, causes the processor to perform operations that further comprising:
review the metadata on the initialization system to identify the plurality of applications deployed in the virtual machine.

15. The computing system of claim 10, wherein the initialization process comprises a first process started during a booting process of the computer system and continues as a daemon process that continues running until the computer system is shut down.

16. The computing system of claim 10, wherein the container specification indicates the contents of a container image, and wherein the container specification is encoded in form of a sequence of instructions that generates each container.

17. The computerized system of claim 10, wherein the memory further contains instructions when executed on the processor, causes the processor to perform operations that further comprising:
target the second virtual machine for implementation on a specified cloud platform by selecting an appropriate base-operating system image built for the specified cloud platform.

18. The computerized system of claim 10, wherein the memory further contains instructions when executed on the processor, causes the processor to perform operations that further comprising:
layer an application state of each application in the second virtual machine as indicated by the container specification.
